(19) United States
(12) Patent Application Publication
(10) Pub. No.: US 2016/0334959 A1
(43) Pub. Date: Nov. 17, 2016

(54) ELECTRONIC DEVICE AND APPLICATION LAUNCHING METHOD

(71) Applicant: FIH (HONG KONG) LIMITED, Kowloon (HK)

(72) Inventor: SHENG-YI LU, New Taipei (TW)

(21) Appl. No.: 14/713,789

(22) Filed: May 15, 2015

(51) Int. Cl. G06F 3/0488; G06F 3/0484; G06F 3/0482

(52) U.S. Cl. CPC G06F 3/0488; G06F 3/0482; G06F 3/04842

(57) ABSTRACT

A method for launching a further program even though another application is already open controls a touch screen to display a drawing area, and detects one or more touch positions in the drawing area to determine a touch track. The method further recognizes a shape of the touch track, determines whether a template similar to the input shape is existed, and launches one application corresponding to the template similar to the shape according to the relationship between the templates and the applications when the template similar to the shape is existed. A related electronic device and a related non-transitory storage medium are also provided.

### CROSS-REFERENCE TO RELATED APPLICATIONS

This application claims priority to Taiwanese Patent Application No. 103137542 filed on Oct. 30, 2014, the contents of which are incorporated by reference herein.

### FIELD

The subject matter herein generally relates to program management when another application has been launched.

### BACKGROUND

Launching a desired application when another application is running is common in an electronic device. However, before launching the desired application, the running application needs to be quitted and user must return to the menu to search for the desired application.

### BRIEF DESCRIPTION OF THE DRAWINGS

Implementations of the present technology will now be described, by way of example only, with reference to the attached figures, wherein:

FIG. 1 illustrates a block diagram of an embodiment of an electronic device.

FIG. 2 illustrates a block diagram of an embodiment of an application launching system.

FIG. 3 illustrates a diagrammatic view of a relationship between a number of templates and a number of applications.

FIG. 4 illustrates a trigger button, a drawing area, and a determining virtual button on the electronic device of FIG. 1.

FIG. 5 illustrates a series of processes for launching an application.

FIG. 6 illustrates applications corresponding to a template.

FIG. 7 illustrates a flowchart of an embodiment of an application launching method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device.

The term “comprising” means “including, but not necessarily limited to”; it specifically indicates open-ended inclusion or membership in a so-described combination, group, series and the like.

Embodiments of the present disclosure will be described with reference to the accompanying drawings.

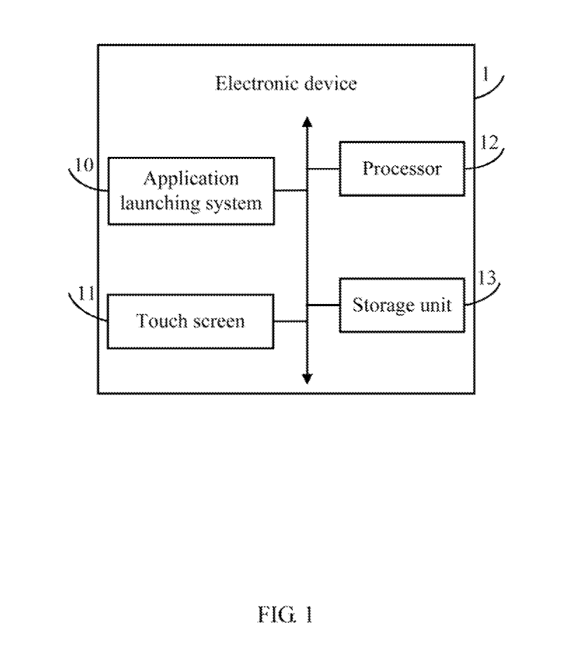

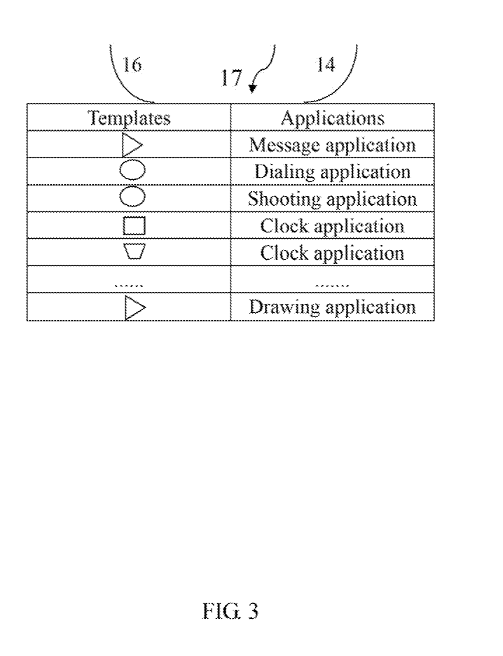

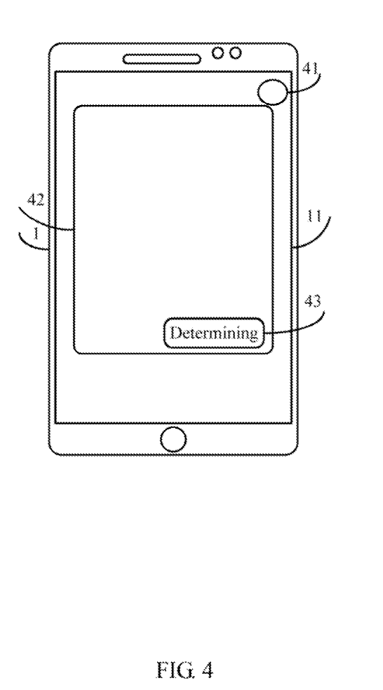

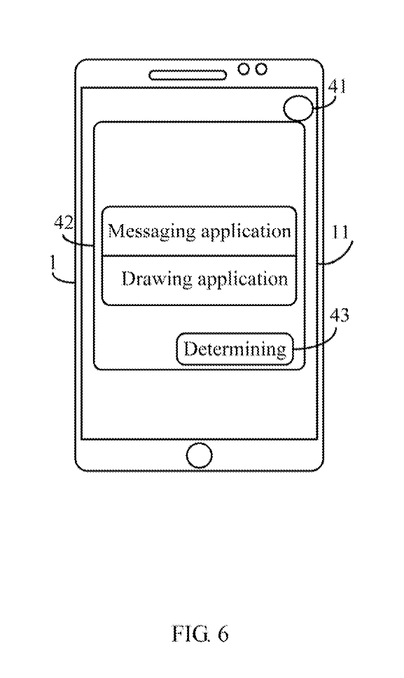

FIG. 1 illustrates a block diagram of an embodiment of an electronic device 1. In the embodiment, the electronic device 1 can be a smart phone, a personal digital assistant (PDA), and the like. The electronic device 1 can include, but is not limited to, a touch screen 11, a processor 12, and a storage unit 13. In the embodiment, the touch screen 11 can be a single-point touch screen or a multi-point touch screen. In the embodiment, the touch screen 11 can be coupled to the processor 12 and configured to display information. In the embodiment, the processor 12 can be a central processing unit, a digital signal processor, or a single chip, for example. In the embodiment, the storage unit 13 can be a hard disk, a compact disk, or a flash memory, for example. The flash memory can be a smart media (SM) card, a compact flash (CF) card, a secure digital (SD) card, an xd-picture (XD) card, or the like. In the embodiment, the storage unit 13 can be coupled to the processor 12. In the embodiment, the electronic device 1 can include system software and a number of applications 14 (see FIG. 3). The system software can be software to provide a platform for running applications 14. The applications 14 can include a console game application, a drawing application, a painting application, a message application, a shooting application, a dialing application, a clock application, and the like. In the embodiment, the electronic device 1 can detect whether a trigger button 41 (see FIG. 4) is activated, display a drawing area 42 (see FIG. 4) when the trigger button 41 is activated and receive a user input of a shape 15 (see FIG. 6) traced in the drawing area 42. The electronic device 1 can further launch one application 14 corresponding to a template 16 (see FIG. 3) similar to the shape 15.

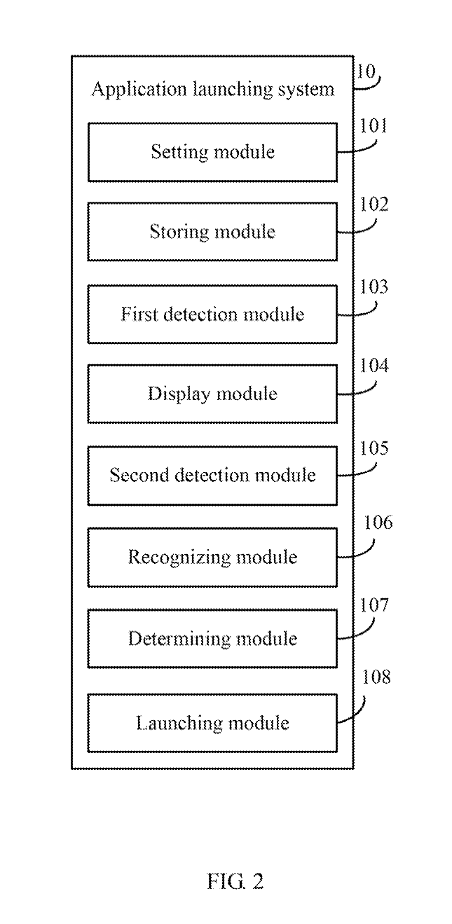

In the embodiment, the electronic device 1 can further include an application launching system 10 as shown in FIG. 2. In the embodiment, the application launching system 10 can include a setting module 101, a storing module 102, a first detection module 103, a display module 104, a second detection module 105, a recognizing module 106, a determining module 107, and a launching module 108. One or more programs of the function modules of the application launching system 10 can be stored in the storage unit 13 and executed by the processor 12.

In the embodiment, the setting module 101 can be configured to set a relationship 17 between the templates 16 and the applications 14. In the embodiment, the templates 16 can be input by the user or can be default templates. In the embodiment, the setting module 101 can provide a user interface for the user to input the templates 16. In the embodiment, the templates 16 can be graph templates and/or character templates. The graph templates can include template of a round, template of a triangle, template of a ring, and the like. The character templates can be templates of letters (e.g. A), and the like. In the embodiment, the setting module 101 can provide an interface for the user to assign templates 16 for the applications 14 one by one to set the relationship 17 between the templates 16 and the applications 14. In the embodiment, the relationship 17 between the templates 16 and the applications 14 can be edited by the user, for example, the user can reassign the template of the triangle for the message application instead of the template of the ring for the message application, or when the painting application is newly installed, the user can add a relationship between the template of the round and the painting application, or when the drawing application is uninstalled, the user can cancel a relationship between the template of a triangle and the drawing application. In the embodiment, the relationship 17 between the templates 16 and the applications 14 can be one template 16 corresponding to one application 14, or one template 16 corresponding to a number of applications 14, or a number of templates 16 corresponding to one application 14. For example, as shown in FIG. 3, the template of the triangle can correspond to the message application, the template of the round can correspond to the dialing application and to the shooting application, and the template of the rectangle and the template of the trapezium can both correspond to the clock application.

In the embodiment, the storing module 102 can be configured to store the relationship 17 between the templates 16 and the applications 14 in the storage unit 13.

In the embodiment, the first detection module 103 can be configured to detect whether a trigger button 41 is activated. In the embodiment, the trigger button 41 can be a physical button or a virtual button. In the embodiment, the physical trigger button 41 can be arranged on a sidewall of the electronic device 1, or on a top of the electronic device 1, or any other suitable position. In the embodiment, the virtual trigger button 41 can be constantly displayed on the touch screen 11 when the electronic device 1 is activated, or can be displayed on the touch screen 11 in response to user operation on a physical button. In the embodiment, the virtual trigger button 41 can be displayed on top. In the embodiment, the position of the virtual trigger button 41 can be fixed on the touch screen 11, or can be changed on the touch screen 11 in response to user operation or automatically at preset intervals. In the embodiment, the shape, the size, and the color of the virtual trigger button 41 can be preset or can be by default. For example, as shown in FIG. 4, the shape of the virtual trigger button 41 is round and the position of the virtual trigger button 41 is on an upper right corner of the touch screen 11.

In the embodiment, the display module 104 can be configured to control the touch screen 11, to display the drawing area 42 when the trigger button 41 is activated. In the embodiment, the drawing area 42 can be displayed on top or can replace the application 14 currently run. In the embodiment, the display module 104 can be further configured to control the touch screen 11 to display a determining virtual button 43. In the embodiment, the determining virtual button 43 can be displayed in the drawing area 42, below the drawing area 42, or any other suitable position. In the embodiment, the display module 104 can be further configured to stop displaying the drawing area 42 when no touch is detected in the drawing area 42 for a preset time (e.g. 1 minute).

In the embodiment, the second detection module 105 can be configured to detect one or more touch positions in the drawing area 42 to determine a touch track. In detail, the second detection module 105 can be configured to detect the user operation in the drawing area 42 to determine one or more touch positions, and detect a movement of the one or more touch positions to determine the touch track. In the embodiment, the determining virtual button 43 can be displayed by the second detection module 105 rather than by the display module 104. The second detection module 105 can be further configured to control the touch screen 11 to display the determining virtual button 43 upon detecting the user operation in the drawing area 42.

In the embodiment, the recognizing module 106 can be configured to recognize a shape 15 of the touch track. In the embodiment, the recognizing module 106 can be configured to recognize the shape 15 of the touch track upon pressing or touching the determining virtual button 43. The method of recognizing the shape 15 of the touch track is known in related technology, and the detail of shape recognition is not described herein.

In the embodiment, the determining module 107 can be configured to determine whether a template 16 similar to the shape 15 is existed in the storage unit 13. In the embodiment, the determining module 107 can be configured to determine a number of graphs and/or characters similarity to the recognized shape 15, display the graphs and/or characters for the user to select one, and determine whether a stored template 16 matches with the selected graph or character to determine whether a template 16 similar to the shape 15 is existed in the storage unit 13.

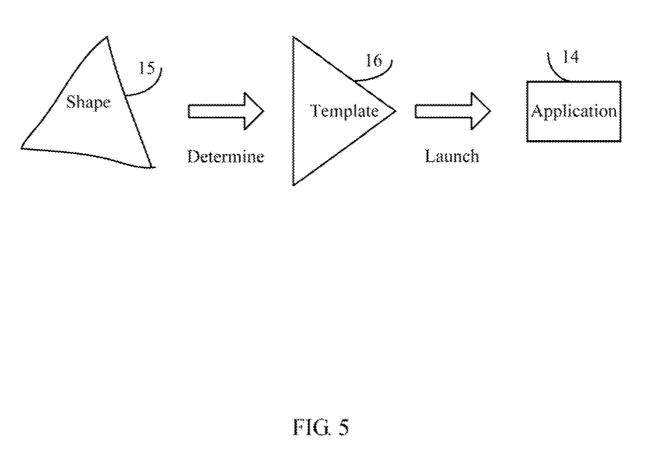

In the embodiment, as shown in FIG. 5, the launching module 108 can be configured to launch one application 14 corresponding to the template 16 similar to the shape 15 according to the relationship 17 between the templates 16 and the applications 14 when a template 16 similar to the shape 15 is existed in the storage unit 13. In the embodiment, when the number of applications 14 corresponding to the template 16 is one, the launching module 108 can directly launch the application 14 corresponding to the template 16. In the embodiment, as shown in FIG. 6, when the number of applications 14 corresponding to the template 16 is more than one, the launching module 108 can provide a prompt listing all applications 14 corresponding to the template 16, to prompt the user to select one application 14 from all the applications 14 corresponding to the template 16. The launching module 108 can be further configured to, in response to user operation of selecting one application 14 from all the applications 14 corresponding to the template 16, launch the selected application 14.

In the embodiment, the determining module 107 can be further configured to generate a prompt to prompt that an input is wrong when no template 16 similar to the shape 15 is existed in the storage unit 13. In the embodiment, the recognizing module 106 can be further configured to prompt the user to re-input in the drawing area 42 again.

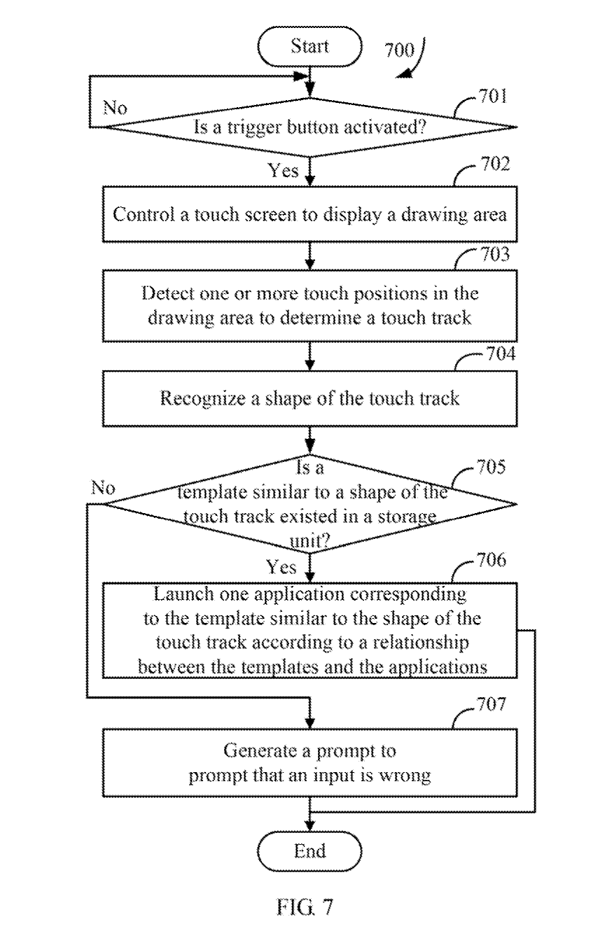

FIG. 7 illustrates a flowchart of an embodiment of an application launching method 700. The method 700 is provided by way of example, as there are a variety of ways to carry out the method 700. The method 700 described below can be carried out using the configurations illustrated in FIGS. 1-2, for example, and various elements of these figures are referenced in the explanation of method. Each block shown in FIG. 2 represents one or more processes, methods, or subroutines, carried out in the method. Furthermore, the illustrated order of blocks is by example only and the order of the blocks can change. Additional blocks may be added or fewer blocks may be utilized, without departing from this disclosure. The method 700 can begin at block 701.

At block 701, a first detection module detects whether a trigger button is activated. When the trigger button is activated, the procedure goes to block 702. When the trigger button is not activated, the procedure repeats block 701. In the embodiment, the trigger button can be a physical button or a virtual button. In the embodiment, the physical trigger button can be arranged on a sidewall of an electronic device, or on a top of the electronic device, or any other suitable position. In the embodiment, the virtual trigger button can be constantly displayed on a touch screen when the electronic device is activated, or can be displayed on the touch screen in response to user operation on a physical button. In the embodiment, the virtual trigger button can be displayed on top. In the embodiment, the position of the virtual trigger button can be fixed on the touch screen, or can be changed on the touch screen in response to user operation, or automatically at preset intervals. In the embodiment, the shape, the size, and the color of the virtual trigger button can be preset or can be by default.

At block 702, a display module controls a touch screen to display a drawing area. In the embodiment, the drawing area can be displayed on top or can replace the application currently run. In the embodiment, the display module can control the touch screen to display a determining virtual button. In the embodiment, the determining virtual button can be displayed in the drawing area, below the drawing area, or any other suitable position. In the embodiment, the display module can be further configured to stop displaying the drawing area when no touch is detected in the drawing area for a preset time (e.g. 1 minute).

At block 703, a second detection module detects one or more touch position in the drawing area to determine a touch track. In detail, the second detection module detects the user operation in the drawing area to determine one or more touch positions, and detects a movement of the one or more touch positions to determine the touch track. In the embodiment, the determining virtual button can be displayed by the second detection module rather than by the display module. The second detection module can further control the touch screen to display the determining virtual button upon detecting the user operation in the drawing area.

At block 704, a recognizing module recognizes a shape of the touch track. In the embodiment, the recognizing module can recognize the shape of the touch track upon pressing or touching the determining virtual button.

At block 705, a determining module determines whether a template similar to the shape is existed in a storage unit. If a template similar to the shape is existed in the storage unit, the procedure goes to block 706. If no template similar to the shape is existed in the storage unit, the procedure goes to block 707. In the embodiment, the recognizing module can determine a number of graphs and/or characters similarity to the recognized shape, display the graphs and/or characters for the user to select one, and determine whether a stored template matches with the selected graph or character to determine whether a template similar to the shape is existed in the storage unit.

At block 706, a launching module launches one application corresponding to the template similar to the shape according to the relationship between the templates and the applications. In the embodiment, when the number of applications corresponding to the template is one, the launching module can directly launch the application corresponding to the template. In the embodiment, when the number of applications corresponding to the template is more than one, the launching module can provide a prompt listing all applications corresponding to the template, to prompt the user to select one application from all the applications corresponding to the template. The launching module can further, in response to user operation of selecting one application from all the applications corresponding to the template, launch the selected application.

At block 707, the determining module generates a prompt to prompt that an input is wrong. In the embodiment, the determining module can further prompt the user to re-input in the drawing area again.

In the embodiment, the method further includes:

A setting module sets a relationship between the templates and the applications. In the embodiment, the templates can be input by the user or can be default templates. In the embodiment, the setting module can provide a user interface for the user to input the templates. In the embodiment, the templates can be graph templates and/or character templates. The graph templates can include template of a round, template of a triangle, template of a ring, and the like. The character templates can be templates of letters (e.g. A), and the like. In the embodiment, the setting module can provide an interface for the user to assign templates for the applications one by one, to set a relationship between the templates and the applications. In the embodiment, the relationship between the templates and the applications can be edited by the user. In the embodiment, the relationship between the templates and the applications can be one template corresponding to one application, or one template corresponding to a number of applications, or a number of templates corresponding to one application.

A storing module stores the relationship between the templates and the applications in the storage unit.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. An electronic device comprising:
a touch screen;
a processor coupled to the touch screen; and
a non-transitory computer readable medium coupled to the processor and storing a relationship between a plurality of templates and a plurality of applications, the non-transitory computer readable medium storing instructions to cause the processor to:
control the touch screen to display a drawing area;
detect one or more touch positions in the drawing area to determine a touch track;
recognize a shape of the touch track;
determine whether a template similar to the shape is existed in the non-transitory computer readable medium; and
launch one application corresponding to the template similar to the shape according to the relationship between the plurality of templates and the plurality of applications when a template similar to the shape is existed in the non-transitory computer readable medium.

2. The electronic device as described in claim 1, wherein the instructions stored in the non-transitory computer readable medium further causes the processor to:
detect whether a trigger button is activated; and
control the touch screen to display the drawing area when the trigger button is activated.

3. The electronic device as described in claim 1, wherein the instructions stored in the non-transitory computer readable medium further causes the processor to:
set a relationship between the plurality of templates and the plurality of applications; and
store the relationship between the plurality of templates and the plurality of applications in the non-transitory computer readable medium.

4. The electronic device as described in claim 1, wherein the instructions stored in the non-transitory computer readable medium further causes the processor to:
control the touch screen to display a determining virtual button; and
recognize the shape of the touch track upon the determining virtual button is activated.

5. The electronic device as described in claim 1, wherein the relationship between the plurality of templates and the plurality of applications is one of the plurality of templates corresponding to one of the plurality of applications, or one of the plurality of templates corresponding to a plurality of applications, or a plurality of templates corresponding to one of the plurality of applications.

6. The electronic device as described in claim 5, wherein the instructions stored in the non-transitory computer readable medium further causes the processor to:
directly launch the application corresponding to the template when the number of applications corresponding to the template is one; and
provide a prompt listing all applications corresponding to the template, to prompt the user to select one application from all the applications corresponding to the template when the number of applications corresponding to the template is more than one, and, in response to the user operation of selecting one application from all the applications corresponding to the template, launch the selected application.

7. The electronic device as described in claim 1, wherein the instructions stored in the non-transitory computer readable medium further causes the processor to:
stop displaying the drawing area when no touch is detected in the drawing area for a preset time.

8. An application launching method comprising:
controlling a touch screen to display a drawing area;
detecting one or more touch positions in the drawing area to determine a touch track;
recognizing a shape of the touch track;
determining whether a template similar to the shape is existed in a non-transitory computer readable medium; and
launching one application corresponding to the template similar to the shape according to a relationship between the templates and the applications when a template similar to the shape is existed in the non-transitory computer readable medium.

9. The application launching method as described in claim 8, wherein the method further comprises:
detecting whether a trigger button is activated; and
controlling the touch screen to display the drawing area when the trigger button is activated.

10. The application launching method as described in claim 8, wherein the method further comprises:
setting a relationship between the templates and the applications; and
storing the relationship between the templates and the applications in the non-transitory computer readable medium.

11. The application launching method as described in claim 8, wherein the method further comprises:
controlling the touch screen to display a determining virtual button; and
recognizing the shape of the touch track upon the determining virtual button is activated.

12. The application launching method as described in claim 8, wherein the relationship between the templates and the applications is one of the templates corresponding to one of the applications, or one of the templates corresponding to a plurality of applications, or a plurality of templates corresponding to one of the applications.

13. The application launching method as described in claim 12, wherein the method further comprises:
directly launching the application corresponding to the template when the number of applications corresponding to the template is one; and
providing a prompt listing all applications corresponding to the template, to prompt the user to select one application from all the applications corresponding to the template when the number of applications corresponding to the template is more than one, and, in response to the user operation of selecting one application from all the applications corresponding to the template, launching the selected application.

14. The application launching method as described in claim 8, wherein the method further comprises:
stopping displaying the drawing area when no touch is detected in the drawing area for a preset time.

15. A non-transitory storage medium storing a set of instructions, the set of instructions capable of being executed by a processor of an electronic device, causing the electronic device to perform an application launching method, wherein the method comprises:
controlling a touch screen to display a drawing area;
detecting one or more touch positions in the drawing area to determine a touch track;
recognizing a shape of the touch track;
determining whether a template similar to the shape is existed in a non-transitory computer readable medium; and
launching one application corresponding to the template similar to the shape according to a relationship between the templates and the applications when a template similar to the shape is existed in the non-transitory computer readable medium.

16. The non-transitory storage medium as described in claim 15, wherein the method further comprises:
detecting whether a trigger button is activated; and
controlling the touch screen to display the drawing area when the trigger button is activated.

17. The non-transitory storage medium as described in claim 15, wherein the method further comprises:
setting a relationship between the templates and the applications; and
storing the relationship between the templates and the applications in the non-transitory computer readable medium.

18. The non-transitory storage medium as described in claim 15, wherein the method further comprises:
controlling the touch screen to display a determining virtual button; and
recognizing the shape of the touch track upon the determining virtual button is activated.

19. The non-transitory storage medium as described in claim 15, wherein the relationship between the templates and the applications is one of the templates corresponding to one of the applications, or one of the templates corresponding to a plurality of applications, or a plurality of templates corresponding to one of the applications.

20. The non-transitory storage medium as described in claim 19, wherein the method further comprises:
directly launching the application corresponding to the template when the number of applications corresponding to the template is one; and
providing a prompt listing all applications corresponding to the template, to prompt the user to select one application from all the applications corresponding to the template when the number of applications corresponding to the template is more than one, and, in response to the user operation of selecting one application from all the applications corresponding to the template, launching the selected application.
